(19) United States
(12) Patent Application Publication
(10) Pub. No.: US 2026/0261971 A1
(43) Pub. Date: Sep. 3, 2026

(54) METHOD AND DEVICE FOR LOW POWER OPERATION IN WIRELESS LAN SUPPORTING MULTIPLE LINKS

(71) Applicants: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(72) Inventors: Yong Ho Kim, Incheon (KR); Ju Seong Moon, Osan-si, Gyeonggi-do (KR)

(73) Assignees: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(21) Appl. No.: 18/876,070

(22) PCT Filed: Sep. 5, 2023
(86) PCT No.: PCT/KR2023/013268

§ 371 Date: Dec. 17, 2024

(30) Foreign Application Priority Data
Sep. 6, 2022 (KR) 10-2022-0112975
Mar. 2, 2023 (KR) 10-2023-0028096

(51) Int. Cl. H04W 52/02; H04W 76/15; H04W 84/12

(52) U.S. Cl. CPC H04W 52/0235; H04W 52/0216; H04W 76/15; H04W 84/12

(57) ABSTRACT

Disclosed are a method and device for low power operation in a wireless LAN supporting multiple links. A method of a first device comprises the steps in which: a first STA associated with the first device performs communication with a first AP in a first link; a second STA associated with the first device performs a power reduction operation in a second link during a period in which the communication is being performed in the first link; and the second STA operates in an awake state, instead of performing the power reduction operation, in the second link after the communication in the first link has been completed.

### TECHNICAL FIELD

The present disclosure relates to a wireless local area network (LAN) communication technique, and more particularly, to a technique for low-power communication in a wireless LAN supporting multiple links.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The standards that use wireless LAN technology are mainly developed as the Institute of Electrical and Electronics Engineers (IEEE) 802.11 standards. As the aforementioned wireless LAN technology has been developed and widely adopted, applications utilizing wireless LAN technology have diversified, and demand has arisen for wireless LAN technology that supports a higher throughput.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since a multi-link operation is not defined in the existing wireless LAN standards, it may be necessary to define detailed operations according to an environment in which the multi-link operation is performed. For example, feasibility of simultaneous transmit and receive (STR) operation on multiple links may vary depending on a channel condition of the multiple links and/or capability of communication nodes (e.g., AP, station (STA), multi-link device (MLD)). Power-saving methods may be needed to improve the power efficiency of non-STR (NSTR) devices.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for low-power operations of a device in a wireless LAN supporting multiple links.

### Technical Solution

A method of a first device, according to exemplary embodiments of the present disclosure for achieving the above-described objective, may comprise: allowing a first station (STA) affiliated with the first device to perform communication with a first access point (AP) on a first link; allowing a second STA affiliated with the first device to perform a power-saving operation on a second link, during a period in which the communication is performed on the first link; and allowing the second STA to operate in an awake state on the second link instead of the power-saving operation, after the communication is completed on the first link, wherein the first device is a device having a non-simultaneous transmit and receive (NSTR) link pair, and the NSTR link pair is a pair of the first link and the second link.

The period in which the communication is performed may correspond to a length of a frame transmitted by the first STA.

The period in which the communication is performed may correspond to a transmit opportunity (TXOP) configured for the communication.

The period in which the communication is performed may correspond to ‘a transmission/reception period of a frame for configuring a TXOP for the communication+the TXOP’.

The power-saving operation on the second link may be performed during ‘the period in which the communication is performed on the first link+enhanced multi-link single radio (EMLSR) transition delay’.

The EMLSR transition delay may be a time required for a frame transmission/reception procedure in a listening operation according to EMLSR or a time required for transition to the listening operation after completion of the frame transmission/reception procedure.

The method may further comprise, before performing the communication on the first link, transmitting, to the first AP, a frame including power-saving configuration information to the first AP on the first link in order for the first STA to configure the power-saving operation; and receiving a reception response frame for the frame from the first AP.

The frame may be an action frame, a data frame, an association request frame, or a frame according to a multi-link setup procedure.

The power-saving configuration information may include at least one of an indicator indicating whether to perform the power-saving operation, a bitmap indicating link(s) on which the power-saving operation is performed, or a mode of the power-saving operation, and a period in which the power-saving operation is performed may vary depending on the mode.

The method may further comprise: allowing the first STA to transmit a frame including deactivation information of the power-saving operation to the first AP on the first link; and receiving, from the first AP, a reception response frame for the frame, wherein the power-saving operation is deactivated by the deactivation information, and when the power-saving operation is deactivated, the first device does not perform the power-saving operation.

A first device, according to exemplary embodiments of the present disclosure for achieving the above-described objective, may comprise: at least one processor, wherein the at least one processor causes the first device to perform: allowing a first station (STA) affiliated with the first device to perform communication with a first access point (AP) on a first link; allowing a second STA affiliated with the first device to perform a power-saving operation on a second link, during a period in which the communication is performed on the first link; and allowing the second STA to operate in an awake state on the second link instead of the power-saving operation, after the communication is completed on the first link, wherein the first device is a device having a non-simultaneous transmit and receive (NSTR) link pair, and the NSTR link pair is a pair of the first link and the second link.

The period in which the communication is performed may correspond to a length of a frame transmitted by the first STA.

The period in which the communication is performed may correspond to a transmit opportunity (TXOP) configured for the communication.

The period in which the communication is performed may correspond to ‘a transmission/reception period of a frame for configuring a TXOP for the communication+the TXOP’.

The power-saving operation on the second link may be performed during ‘the period in which the communication is performed on the first link+enhanced multi-link single radio (EMLSR) transition delay’.

The at least one processor may further cause the first device to perform, before performing the communication on the first link, transmitting, to the first AP, a frame including power-saving configuration information to the first AP on the first link in order for the first STA to configure the power-saving operation; and receiving a reception response frame for the frame from the first AP.

The frame may be an action frame, a data frame, an association request frame, or a frame according to a multi-link setup procedure.

The power-saving configuration information may include at least one of an indicator indicating whether to perform the power-saving operation, a bitmap indicating link(s) on which the power-saving operation is performed, or a mode of the power-saving operation, and a period in which the power-saving operation is performed may vary depending on the mode.

The at least one processor may further cause the first device to perform: allowing the first STA to transmit a frame including deactivation information of the power-saving operation to the first AP on the first link; and receiving, from the first AP, a reception response frame for the frame, wherein the power-saving operation is deactivated by the deactivation information, and when the power-saving operation is deactivated, the first device does not perform the power-saving operation.

### Advantageous Effects

According to the present disclosure, a device (e.g., STA, AP, MLD) can perform STR operations on multiple links. The STR operation on multiple links may be possible depending on channel conditions and/or device status. A STA can transmit information indicating the feasibility of STR operation, information on a modulation and coding scheme (MCS), and/or information on the number of spatial streams (NSS) to an AP. Based on the information received from the STA, the AP can dynamically reconfigure multi-link information. In other words, a reconfiguration procedure for multi-link information can be performed between the AP and STA. Through the aforementioned method, communication on multiple links can be smoothly performed.

### DESCRIPTION OF DRAWINGS

FIG. 1 is a block diagram illustrating a first exemplary embodiment of a communication node constituting a wireless LAN system.

FIG. 2 is a conceptual diagram illustrating a first exemplary embodiment of a multi-link configured between multi-link devices (MLDs).

FIG. 3A is a timing diagram illustrating a first exemplary embodiment of a power-saving operation of an NSTR device.

FIG. 3B is a timing diagram illustrating a second exemplary embodiment of a power-saving operation of an NSTR device.

FIG. 3C is a timing diagram illustrating a third exemplary embodiment of a power-saving operation of an NSTR device.

FIG. 4A is a timing diagram illustrating a first exemplary embodiment of a power-saving operation of an EMLSR device.

FIG. 4B is a timing diagram illustrating a second exemplary embodiment of a power-saving operation of an EMLSR device.

FIG. 5A is a timing diagram illustrating a third exemplary embodiment of a power-saving operation of an EMLSR device.

FIG. 5B is a timing diagram illustrating a fourth exemplary embodiment of a power-saving operation of an EMLSR device.

FIG. 6A is a timing diagram illustrating a first exemplary embodiment of a method for configuring a power-saving operation of an NSTR device.

FIG. 6B is a timing diagram illustrating a second exemplary embodiment of a method for configuring a power-saving operation of an NSTR device.

FIG. 6C is a timing diagram illustrating a third exemplary embodiment of a method for configuring a power-saving operation of an NSTR device.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

In exemplary embodiments, ‘configuration of an operation (e.g., transmission operation)’ may mean that ‘configuration information (e.g., information element(s), parameter(s)) for the operation’ and/or ‘information indicating to perform the operation’ is signaled. ‘Configuration of an information element (e.g., parameter)’ may mean that the information element is signaled. ‘Configuration of a resource (e.g., resource region)’ may mean that setting information of the resource is signaled.

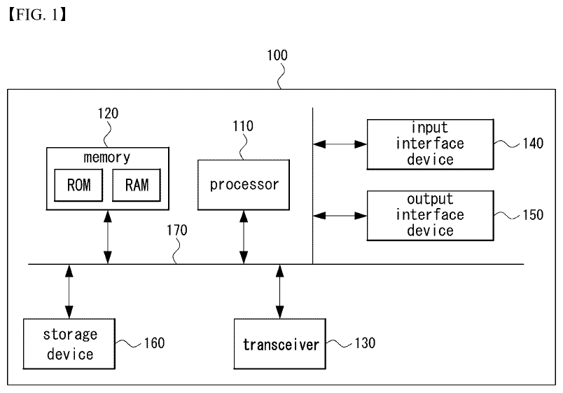

FIG. 1 is a block diagram illustrating a first exemplary embodiment of a communication node constituting a wireless LAN system.

As shown in FIG. 1, a communication node 100 may be an access point, a station, an access point (AP) multi-link device (MLD), or anon-AP MLD. An access point may refer to ‘AP’, and a station may refer to ‘STA’ or ‘non-AP STA’. An operating channel width supported by an AP may be 20 megahertz (MHz), 80 MHz, 160 MHz, or the like. An operating channel width supported by a STA may be 20 MHz, 80 MHz, or the like.

The communication node 100 may include at least one processor 110, a memory 120, and a transceiver 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The respective components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, and the storage device 160 through a dedicated interface.

The processor 110 may execute program commands stored in at least one of the memory 120 and the storage device 160. The processor 110 may refer to a central processing unit (CPU), a graphics processing unit (GPU), or a dedicated processor on which the methods according to the exemplary embodiments of the present disclosure are performed. Each of the memory 120 and the storage device 160 may be configured as at least one of a volatile storage medium and a nonvolatile storage medium. For example, the memory 120 may be configured with at least one of a read only memory (ROM) and a random access memory (RAM).

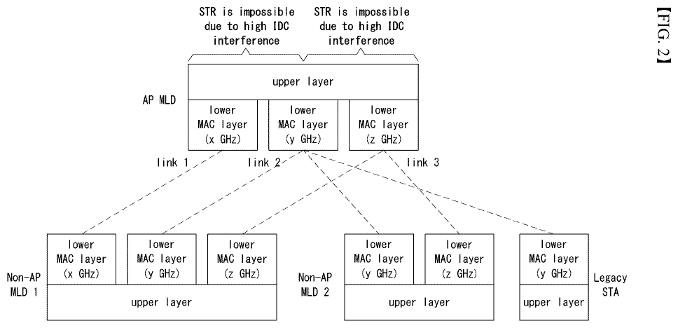

FIG. 2 is a conceptual diagram illustrating a first exemplary embodiment of a multi-link configured between multi-link devices (MLDs).

As shown in FIG. 2, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band).

For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur.

Accordingly, when the bandwidth separation between multiple links is not sufficient, the MLD may not be able to perform an STR operation. A link pair having the above-described interference relationship may be a non-simultaneous transmit and receive (NSTR)-limited link pair. Here, the MLD may be referred to as ‘NSTR AP MLD’ or ‘NSTR non-AP MLD’.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

Meanwhile, in a wireless LAN system, a negotiation procedure for a multi-link operation may be performed in an access procedure between a station and an access point. A device (e.g., access point, station) that supports multiple links may be referred to as ‘multi-link device (MLD)’. An access point supporting multiple links may be referred to as ‘AP MLD’, and a station supporting multiple links may be referred to as ‘non-AP MLD’ or ‘STA MLD’. The AP MLD may have a physical address (e.g., MAC address) for each link. The AP MLD may be implemented as if an AP in charge of each link exists separately. A plurality of APs may be managed within one AP MLD. Therefore, coordination between a plurality of APs belonging to the same AP MLD may be possible. A STA MLD may have a physical address (e.g., MAC address) for each link. The STA MLD may be implemented as if a STA in charge of each link exists separately. A plurality of STAs may be managed within one STA MLD. Therefore, coordination between a plurality of STAs belonging to the same STA MLD may be possible.

For example, an APT of the AP MLD and a STAT of the STA MLD may each be responsible for a first link and perform communication using the first link. An AP2 of the AP MLD and a STA2 of the STA MLD may each be responsible for a second link and perform communication using the second link. The STA2 may receive status change information for the first link on the second link. In this case, the STA MLD may collect information (e.g., status change information) received on the respective links, and control operations performed by the STAT based on the collected information.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP.

In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP. A STA of a STA MLD may refer to a STA affiliated with the STA MLD, and an AP of an AP MLD may refer to an AP affiliated with the AP MLD. When a STA MLD includes a first STA operating on a first link and a second STA operating on a second link, operations of the STA MLD on the first link may be interpreted as operations of the first STA, and operations of the STA MLD on the second link may be interpreted as operations of the second STA. When an AP MLD includes a first AP operating on the first link and a second AP operating on the second link, operations of the AP MLD on the first link may be interpreted as operations of the first AP, and operations of the AP MLD on the second link may be interpreted as operations of the second AP. In exemplary embodiments, a transmission time of a frame may refer to a transmission start time or a transmission end time, and a reception time of a frame may refer to a reception start time or a reception end time. A transmission time may be interpreted as corresponding to a reception time. A time point may be interpreted as a time, and a time may be interpreted as a time point.

Meanwhile, a power-saving operation for a STA MLD (e.g., NSTR STA MLD) will be described.

Among APs included in an AP MLD 1, an AP operating on a first link may be referred to as AP 1-1 (or, the first AP). Among the APs included in the AP MLD 1, an AP operating on a second link may be referred to as AP 1-2 (or, the second AP).

The AP 1-1 and AP 1-2 may be affiliated with the AP MLD 1. Among STAs included in a STA MLD 1, a STA operating on the first link may be referred to as STA 1-1 (or, the first STA). Among the STAs included in the STA MLD 1, a STA operating on the second link may be referred to as STA 1-2 (or, the second STA).

The STA 1-1 and STA 1-2 may be affiliated with the STA MLD 1.

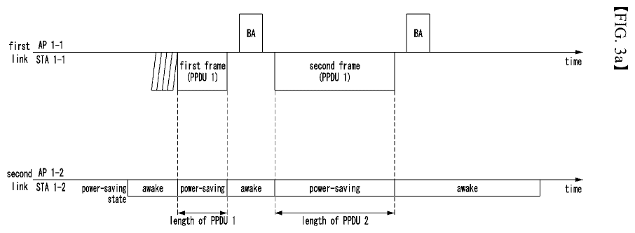

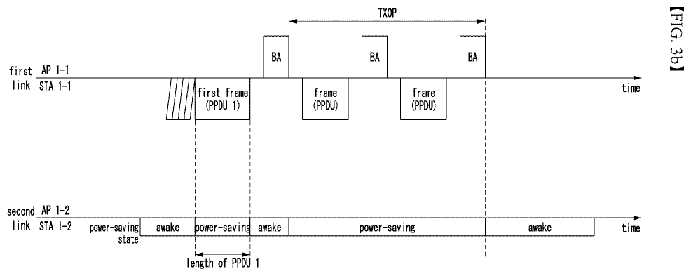

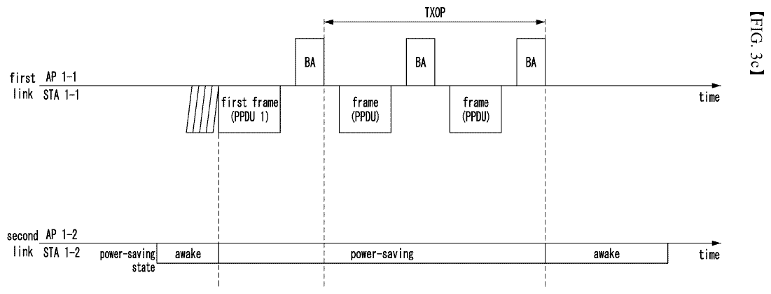

FIG. 3A is a timing diagram illustrating a first exemplary embodiment of a power-saving operation of an NSTR device, FIG. 3B is a timing diagram illustrating a second exemplary embodiment of a power-saving operation of an NSTR device, and FIG. 3C is a timing diagram illustrating a third exemplary embodiment of a power-saving operation of an NSTR device.

As shown in FIGS. 3A to 3C, the STA MLD 1 may be an NSTR STA MLD that does not support STR operations. The first and second links on which the STA MLD 1 operates may be an NSTR link pair. In other words, the STA 1-1 and STA 1-2 may be STAs operating on an NSTR link pair. While the STA MLD transmits a frame (e.g., physical layer protocol data unit (PPDU), MAC protocol data unit (MPDU), or aggregated (A)-MPDU) on one of the multiple links, the STA MLD may not be able to perform a channel sensing and/or frame transmission operation on the other link due to interference caused by the transmission of the frame. Therefore, while a frame is transmitted on the first link, a power-saving operation may be performed on the second link.

For example, while the STA 1-1 transmits a frame to the AP 1-1 on the first link, interference due to the frame transmission on the first link may occur on the second link. Therefore, while the STA 1-1 transmits a frame on the first link, a power-saving operation may be performed on the second link. A state of a STA not performing a power-saving operation may be referred to as an awake state. A state of a STA performing a power-saving operation may be referred to as a power-saving state or multi-link (ML) power-saving state. Alternatively, a state of a STA performing a power-saving operation may be referred to as a doze state. In the present disclosure, a power-saving operation may be a ML power-saving operation.

A communication node (e.g., STA, AP) operating in the awake state may perform transmission and/or reception operations. A communication node operating in the power-saving state may not perform a transmission operation and may only perform a certain reception operation. For example, a communication node operating in the power-saving state may only perform reception of a specific frame (e.g., beacon frame).

In the exemplary embodiment of FIG. 3A, while the STA MLD 1 (e.g., NSTR STA MLD 1) transmits a frame on the first link, a power-saving operation may be performed on the second link. A period in which the power-saving operation is performed on the second link may correspond to a transmission period (e.g., length) of each frame (e.g., each PPDU) on the first link. In other words, a period in which the power-saving operation is performed on the second link may be configured as a transmission period of each frame on the first link. While the STA 1-1 transmits a frame 1 (e.g., PPDU 1, data 1) on the first link, the STA 1-2 may perform a power-saving operation on the second link for a period corresponding to the length of the frame 1. When the transmission of the frame 1 is completed, the STA 1-2 may operate in the awake state instead of performing the power-saving operation. While the STA 1-1 transmits a frame 2 (e.g., PPDU 2, data 2) on the first link, the STA 1-2 may perform a power-saving operation on the second link for a period corresponding to the length of the frame 2. When the transmission of the frame 2 is completed, the STA 1-2 may operate in the awake state instead of performing the power-saving operation.

As another method, while the STA 1-1 transmits a first frame (e.g., PPDU 1, data 1), the STA 1-2 may not perform a power-saving operation. While the STA 1-1 transmits a frame after the first frame, the STA 1-2 may perform a power-saving operation. As another method, if the first frame (e.g., PPDU 1, data 1) transmitted by the STA 1-1 has a form of an A-MPDU, the STA 1-2 may not perform a power-saving operation until a decoding completion time (e.g., reception time) of a MAC header of one or more MPDUs within the A-MPDU. If power-saving information included in the MAC header of one or more MPDUs is obtained by a recipient of the frame, the STA 1-2 may then perform a power-saving operation.

A PPDU may include an A-MPDU, and the A-MPDU may include multiple MPDUs. Transmission of a PPDU may refer to transmission of an A-MPDU or MPDUs included in the A-MPDU.

In the exemplary embodiment of FIG. 3B, when the STA MLD 1 (e.g., NSTR STA MLD 1) transmits a frame on the first link, a power-saving operation may be performed on the second link. The power-saving operation on the second link may be performed for a period corresponding to the length of the first frame (e.g., PPDU 1) transmitted by the STA 1-1 on the first link. In addition, if a transmit opportunity (TXOP) is configured by the transmission of the first frame on the first link, the STA 1-2 may perform a power-saving operation on the second link for a period corresponding to the TXOP.

When the STA 1-1 transmits the first frame (e.g., PPDU 1) on the first link, the STA 1-2 may perform a power-saving operation on the second link for a period corresponding to the length of the first frame. When the transmission or reception of the first frame is completed, the STA 1-2 may operate in the awake state. In other words, the state of the STA 1-2 may transition from the power-saving state to the awake state. This transition operation may mean that the STA 1-2 operates in the awake state instead of performing the power-saving operation.

The AP 1-1 may receive the first frame (e.g., PPDU 1, data 1) from the STA 1-1 and may transmit a reception response frame to the STA 1-1 in response to the first frame. In the present disclosure, the reception response frame may be an acknowledgment (ACK) frame or a block ACK (BA) frame. If the STA 1-1 receives the reception response frame (e.g., BA frame) in response to the first frame, a TXOP may be configured (or granted). In other words, the STA 1-1 may configure a TXOP on the first link, or a TXOP may be granted on the first link. During a period corresponding to the TXOP configured by the STA 1-1 on the first link, the STA 1-2 may perform a power-saving operation on the second link. When the TXOP of the STA 1-1 ends on the first link, the STA 1-2 may terminate the power-saving operation and operate in the awake state. In other words, the state of the STA 1-2 may transition from the power-saving state to the awake state.

As another method, while the STA 1-1 transmits the first frame (e.g., PPDU 1, data 1), the STA 1-2 may not perform a power-saving operation. While the STA 1-1 transmits a frame after the first frame, the STA 1-2 may perform a power-saving operation. As another method, if the first frame (e.g., PPDU 1, data 1) transmitted by the STA 1-1 has a form of an A-MPDU, the STA 1-2 may not perform a power-saving operation until a decoding completion time (e.g., reception time) of a MAC header of one or more MPDUs within the A-MPDU. If power-saving information included in the MAC header of one or more MPDUs is obtained by a recipient of the frame, the STA 1-2 may then perform a power-saving operation.

A PPDU may include an A-MPDU, and the A-MPDU may include multiple MPDUs. Transmission of a PPDU may refer to transmission of an A-MPDU or MPDUs included in the A-MPDU.

In the exemplary embodiment of FIG. 3C, when the NSTR STA MLD 1 transmits a frame on the first link, a power-saving operation may be performed on the second link. For example, the power-saving operation on the second link may be performed for a period corresponding to a TXOP configured on the first link. The power-saving operation on the second link may be performed for a period corresponding to ‘transmission time of the frame (e.g., PPDU 1) for configuring the TXOP+inter-frame space (IFS) (e.g., short inter-frame space (SIFS))+transmission time of a reception response frame for the frame+TXOP’. In other words, the power-saving operation on the second link may be performed for a period corresponding to ‘transmission and reception period of the frame for configuring the TXOP+TXOP’. Alternatively, the TXOP may be granted to the STA 1-1 if the STA 1-1 decides to transmit a frame. The power-saving operation on the second link may be performed for a period corresponding to the TXOP on the first link.

The STA 1-1 may transmit frame(s) (e.g., PPDU(s)) on the first link, and the STA 1-2 may perform a power-saving operation during the entire period in which the STA 1-1 performs transmission and reception operations. When the TXOP of the STA 1-1 ends, the STA 1-2 may operate in the awake state. In other words, the state of the STA 1-2 may transition from the power-saving state to the awake state.

As another method, while the STA 1-1 transmits the first frame (e.g., PPDU 1, data 1), the STA 1-2 may not perform a power-saving operation. While the STA 1-1 transmits a frame after the first frame, the STA 1-2 may perform a power-saving operation. As another method, if the first frame (e.g., PPDU 1, data 1) transmitted by the STA 1-1 has a form of an A-MPDU, the STA 1-2 may not perform a power-saving operation until a decoding completion time (e.g., reception time) of a MAC header of one or more MPDUs within the A-MPDU. If power-saving information included in the MAC header of one or more MPDUs is obtained by a recipient of the frame, the STA 1-2 may then perform a power-saving operation.

A PPDU may include an A-MPDU, and the A-MPDU may include multiple MPDUs. Transmission of a PPDU may refer to transmission of an A-MPDU or MPDUs included in the A-MPDU.

In the exemplary embodiments of FIG. 3B and FIG. 3C, a TXOP on the first link may not be properly configured (or granted). For example, if a reception response frame for the first frame (e.g., PPDU 1) transmitted by the STA 1-1 to configure a TXOP or obtain a granted TXOP is not received within a time corresponding to AckTimeout (e.g., aSIFSTime+aSlotTime+aRxPHYStartDelay), the TXOP may not be configured or granted on the first link. If a TXOP is not configured or granted on the first link, the STA 1-2 may terminate the power-saving operation on the second link and operate in the awake state. In other words, the state of STA 1-2 may transition from the power-saving state to the awake state.

Meanwhile, a power-saving operation for an enhanced multi-link single radio (EMLSR) STA MLD will be described.

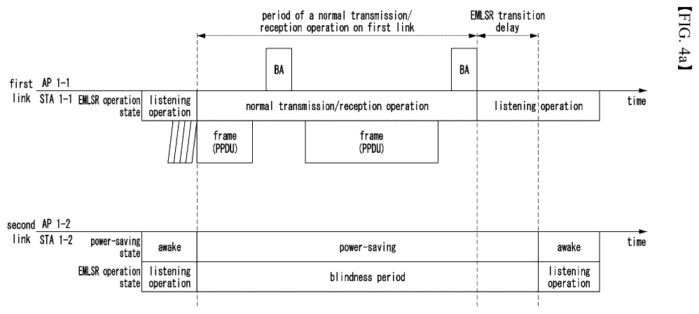

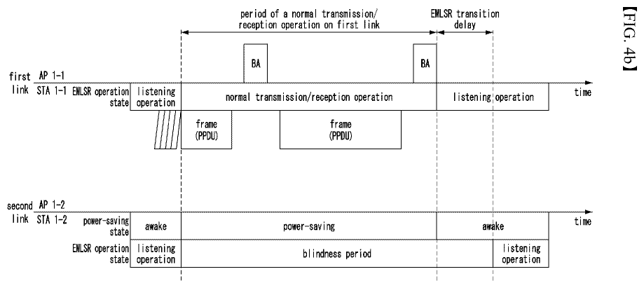

FIG. 4A is a timing diagram illustrating a first exemplary embodiment of a power-saving operation of an EMLSR device, and FIG. 4B is a timing diagram illustrating a second exemplary embodiment of a power-saving operation of an EMLSR device.

As shown in FIGS. 4A and 4B, a STA MLD 1 may be an EMLSR STA MLD that performs EMLSR operations. The STA MLD 1 may perform EMLSR operations on a first link and a second link. In other words, the first link and the second link may be EMLSR links. The STA MLD 1 may wait to receive an initial control frame on the first link and the second link. In other words, STAs affiliated with the STA MLD 1 (e.g., STA 1-1 and STA 1-2) may perform a listening operation. The listening operation may be an operation of waiting to receive an initial control frame. The initial control frame may be a multi-user request to send (MU-RTS) frame or a buffer status report poll (BSRP) frame. The MU-RTS frame may be an MU-RTS trigger frame, and the BSRP frame may be a BSRP trigger frame.

The STA 1-1 of the STA MLD 1 may perform a backoff operation in the listening state to transmit a frame (e.g., uplink frame) to the AP 1-1. The STA 1-1 may initiate frame transmission by transitioning from a listening state to a normal transmission/reception state. The listening state may refer to a state in which the STA performs a listening operation. The normal transmission/reception state may refer to a state in which the STA performs a normal transmission and reception operation. In the normal transmission/reception state, the STA may perform a channel sensing operation and/or a frame transmission/reception operation.

A specific time may be required for the transition from the listening state to the normal transmission/reception state. A specific time may also be required for the transition from the normal transmission/reception state to the listening state. The specific time may be an EMLSR transition delay and/or EMLSR padding delay. The EMLSR transition delay and/or EMLSR padding delay may be referred to as ‘transition delay’. The transition delay may be a time required for a frame transmission/reception procedure in a listening operation (e.g., listening state) according to EMLSR. Alternatively, the transition delay may be a time required for the transition to the listening operation (e.g., listening state) after completion of the frame transmission/reception procedure. While the STA 1-1 performs a normal transmission/reception operation on the first link, the STA 1-2 may be in a blindness state on the second link. In other words, a period in which the normal transmission/reception operation is performed on the first link may correspond to a blindness period on the second link. In the blindness period, the STA (e.g., STA 1-2) may not be able to perform a channel sensing operation and/or frame transmission/reception operation. Therefore, the STA 1-2 may perform a power-saving operation during the blindness period. The power-saving operation during the blindness period may be the same as or similar to the power-saving operation (e.g., ML power-saving operation) in the exemplary embodiments of FIG. 3A, FIG. 3B, and/or FIG. 3C.

In the exemplary embodiment of FIG. 4A, the period in which the STA 1-2 performs the power-saving operation on the second link may correspond to ‘the period in which the normal transmission/reception operation are performed on the first link+EMLSR transition delay’. After the EMLSR transition delay on the first link, the STA 1-2 may terminate the power-saving operation on the second link and operate in the awake state. In other words, the state of STA 1-2 may transition from the power-saving state to the awake state.

In the exemplary embodiment of FIG. 4B, the period in which the STA 1-2 performs the power-saving operation on the second link may not include the EMLSR transition delay. In other words, the period in which STA 1-2 performs the power-saving operation on the second link may correspond to the period in which the normal transmission/reception operation is performed on the first link. After the normal transmission/reception operation is completed on the first link, the STA 1-2 may terminate the power-saving operation on the second link and operate in the awake state. In other words, the state of the STA 1-2 may transition from the power-saving state to the awake state.

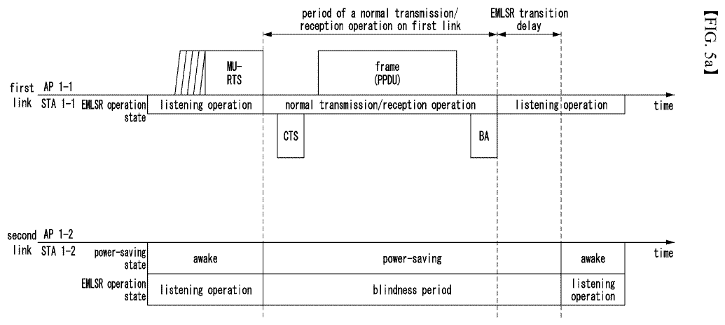

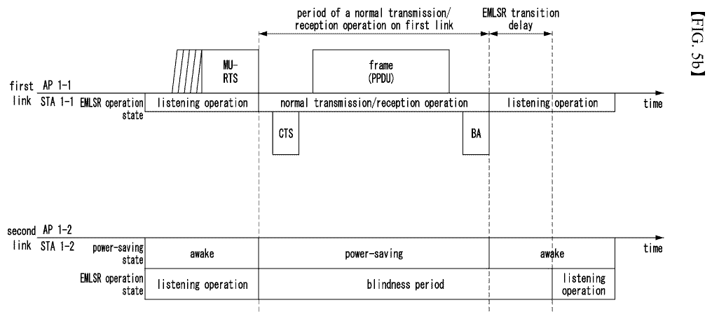

FIG. 5A is a timing diagram illustrating a third exemplary embodiment of a power-saving operation of an EMLSR device, and FIG. 5B is a timing diagram illustrating a fourth exemplary embodiment of a power-saving operation of an EMLSR device.

As shown in FIGS. 5A and 5B, a STA MLD 1 may be an EMLSR STA MLD that performs EMLSR operations. The STA MLD 1 may perform EMLSR operations on a first link and a second link. In other words, the first link and the second link may be EMLSR links. The STA MLD 1 may wait to receive an initial control frame on the first link and the second link. In other words, STAs affiliated with the STA MLD 1 (e.g., STA 1-1 and STA 1-2) may perform a listening operation. The listening operation may be an operation of waiting to receive an initial control frame. The initial control frame may be an MU-RTS frame or a BSRP frame. The MU-RTS frame may be an MU-RTS trigger frame, and the BSRP frame may be a BSRP trigger frame.

The STA 1-1 of the STA MLD 1 may receive an initial control frame from the AP 1-1. Upon receiving the initial control frame, the STA MLD 1 (e.g., STA 1-1) may perform a normal transmission and reception operation on the first link. The STA 1-1 may transmit a clear to send (CTS) frame or another response frame in response to the initial control frame of the AP 1-1. During the normal transmission and reception operation, the STA 1-1 may receive a downlink frame from the AP 1-1.

A specific time may be required for the transition from the listening state to the normal transmission/reception state. A specific time may also be required for the transition from the normal transmission/reception state to the listening state. The specific time may be an EMLSR transition delay and/or EMLSR padding delay. The EMLSR transition delay and/or EMLSR padding delay may be referred to as ‘transition delay’. While the STA 1-1 is performing the normal transmission and reception operation on the first link, the STA 1-2 may be in a blindness state on the second link. In other words, a period in which the normal transmission/reception operation is performed on the first link may correspond to a blindness period on the second link. In the blindness period, the STA (e.g., STA 1-2) may not be able to perform a channel sensing operation and/or frame transmission/reception operation. Therefore, the STA 1-2 may perform a power-saving operation during the blindness period. The power-saving operation during the blindness period may be the same as or similar to the power-saving operation (e.g., ML power-saving operation) in the exemplary embodiments of FIG. 3A, FIG. 3B, and/or FIG. 3C.

In the exemplary embodiment of FIG. 5A, the period in which the STA 1-2 performs the power-saving operation on the second link may correspond to ‘the period in which the normal transmission/reception operation is performed on the first link+EMLSR transition delay’. After the EMLSR transition delay on the first link, the STA 1-2 may terminate the power-saving operation on the second link and operate in the awake state. In other words, the state of STA 1-2 may transition from the power-saving state to the awake state.

In the exemplary embodiment of FIG. 5B, the period in which the STA 1-2 performs the power-saving operation on the second link may not include the EMLSR transition delay. In other words, the period in which the STA 1-2 performs the power-saving operation on the second link may correspond to the period in which the normal transmission/reception operation is performed on the first link. After the normal transmission/reception operation is completed on the first link, the STA 1-2 may terminate the power-saving operation on the second link and operate in the awake state. In other words, the state of STA 1-2 may transition from the power-saving state to the awake state.

A PPDU may include an A-MPDU, and the A-MPDU may include multiple MPDUs. Transmission of a PPDU may refer to transmission of an A-MPDU or MPDUs included in the A-MPDU.

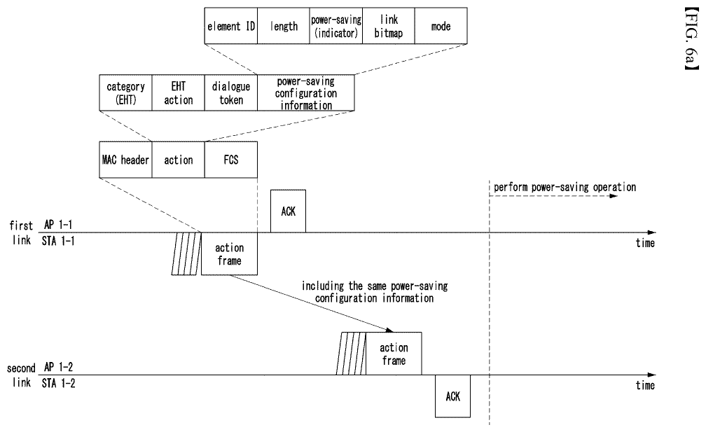

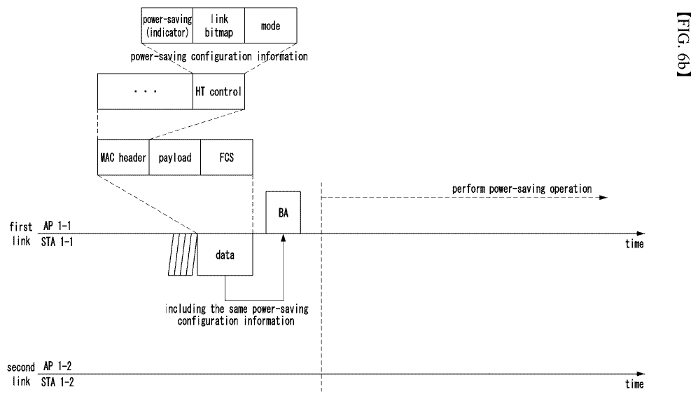

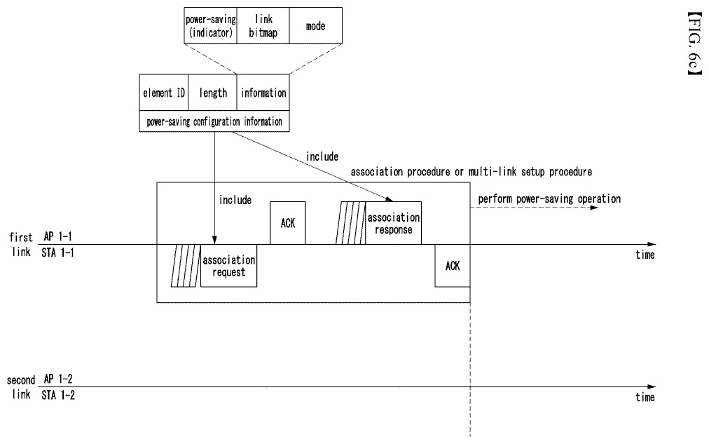

FIG. 6A is a timing diagram illustrating a first exemplary embodiment of a method for configuring a power-saving operation of an NSTR device, FIG. 6B is a timing diagram illustrating a second exemplary embodiment of a method for configuring a power-saving operation of an NSTR device, and FIG. 6C is a timing diagram illustrating a third exemplary embodiment of a method for configuring a power-saving operation of an NSTR device.

As shown in FIGS. 6A to 6C, a STA MLD may configure a power-saving operation with an AP MLD. The power-saving operation may be a ML power-saving operation. For example, the STA MLD 1 may transmit one or more information elements for configuring the power-saving operation to the AP MLD 1. The one or more information elements for configuring the power-saving operation may be the information element(s) defined in Table 1 below.

TABLE 1
Information elements

Information indicating whether to perform a power-saving operation
Bitmap (i.e., link bitmap) indicating link(s) on which the power-saving operation
is performed
Mode of the power-saving operation (e.g., the power-saving operation for each
PPDU in the exemplary embodiment of FIG. 3A, the power-saving operation
within a TXOP in the exemplary embodiment of FIG. 3B, or the power-saving
operation in the entire period related to a TXOP in the exemplary embodiment of
FIG. 3C)

The information (e.g., information element(s)) for configuring the power-saving operation may comprise multiple fields. The information for configuring the power-saving operation may be referred to as ‘power-saving configuration information’. The power-saving configuration information may be included in an action frame. Alternatively, the power-saving configuration information may be included in an HT control field of a MAC header of a data frame.

A power-saving indicator included in the power-saving configuration information may indicate whether to use the power-saving operation. For example, the power-saving indicator may indicate an enabled or disabled state of the power-saving operation. The size of the power-saving indicator may be 1 bit. The power-saving indicator set to a first value (e.g., 0) may indicate deactivation of the power-saving operation. The deactivation of the power-saving operation may mean that the power-saving operation is not performed. The power-saving indicator set to a second value (e.g., 1) may indicate activation of the power-saving operation. The activation of the power-saving operation may mean that the power-saving operation is performed.

When the power-saving indicator is set to the second value, link(s) on which the power-saving operation is performed may be indicated by a link bitmap. Through the above-described method, the link(s) on which the power-saving operation is performed may be configured. After configuring the link(s) on which the power-saving operation is performed, to change the link(s) on which the power-saving operation is performed, the power-saving indicator may be set to the second value, and the link bitmap may indicate the changed link(s).

After configuring the link(s) on which the power-saving operation is performed, to deactivate the power-saving operation, the power-saving indicator may be set to the first value, and all bits in the link bitmap may be set to 0. Alternatively, after configuring the link(s) on which the power-saving operation is performed, to deactivate the power-saving operation, the power-saving indicator may be set to the first value. In this case, the link bitmap may not be used. In other words, the power-saving configuration information may not include the link bitmap.

The STA MLD may configure its power-saving operation by transmitting the power-saving configuration information to the AP MLD. To change the power-saving operation, the STA MLD may transmit updated power-saving configuration information to the AP MLD multiple times. The AP MLD may transmit power-saving configuration information to the STA MLD in response to the power-saving indicator of the STA MLD. For example, the STA MLD may transmit power-saving configuration information including a power-saving indicator set to the second value (e.g., 1) to the AP MLD. The AP MLD may transmit power-saving configuration information to the STA MLD in response to the power-saving indicator.

For example, the AP MLD may reject a power-saving operation of the STA MLD. In this case, the power-saving indicator included in the power-saving configuration information transmitted by the AP MLD to the STA MLD may be set to the first value (e.g., 0). If the power-saving indicator of the AP MLD is set to the first value, the STA MLD may not perform the power-saving operation. Alternatively, the AP MLD may accept a power-saving operation of the STA MLD. In this case, the power-saving indicator included in the power-saving configuration information transmitted by the AP MLD to the STA MLD may be set to the second value (e.g., 1). If the power-saving indicator of the AP MLD is set to the second value, the STA MLD may perform the power-saving operation.

In the exemplary embodiment of FIG. 6A, an action frame may include the power-saving configuration information (e.g., power-saving information). The STA MLD 1 may transmit the action frame including the power-saving configuration information to the AP MLD 1. The AP MLD 1 may receive the action frame from the STA MLD 1. The AP MLD 1 may transmit a reception response frame (e.g., ACK frame) for the action frame of the STA MLD 1 to the STA MLD 1.

Alternatively, the AP MLD 1 may not transmit a reception response frame for the action frame of the STA MLD 1.

The AP MLD 1 may identify the power-saving configuration information received from the STA MLD 1. To indicate that the power-saving configuration information of the STA MLD 1 has been received, the AP MLD 1 may transmit an action frame including power-saving configuration information to the STA MLD 1. For example, the AP MLD 1 may transmit its action frame on the link on which the action frame from the STA MLD 1 has been received. Alternatively, the AP MLD 1 may transmit the action frame on one of the links on which the STA MLD 1 is operating.

For example, the AP MLD 1 may receive the action frame including power-saving configuration information from the STA MLD 1 on the first link, and, in response to the action frame, the AP MLD 1 may transmit an action frame including power-saving configuration information to the STA MLD 1 on the second link. The power-saving configuration information included in the action frame received from the STA MLD 1 on the first link may be the same as the power-saving configuration information included in the action frame transmitted by AP MLD 1 on the second link. The action frame may include not only the power-saving configuration information but also information for reconfiguring STR capability information.

In the exemplary embodiment of FIG. 6B, an HT control field in a MAC header of a frame may include power-saving configuration information (e.g., power-saving information). The power-saving configuration information may be included in a form of an A-control in the HT control field. In other words, the power-saving configuration information may be included in an A-control field. The STA MLD 1 may transmit a frame (e.g., a data frame and/or another frame) including the power-saving configuration information to the AP MLD 1. The AP MLD 1 may receive the frame including the power-saving configuration information from the STA MLD 1 and may transmit a reception response frame for the frame to the STA MLD 1. The response frame may include power-saving configuration information, which may be included in an HT control field of the reception response frame. The power-saving configuration information included in the reception response frame may be the same as the power-saving configuration information received from the STA MLD 1.

Alternatively, the AP MLD 1 may transmit a reception response frame including a QoS-Null frame in response to the frame received from the STA MLD 1. The QoS-Null frame may be included in the reception response frame in a form of an A-MPDU. An HT control field of the QoS-Null frame may include the power-saving configuration information. The power-saving configuration information included in the QoS-Null frame of the AP MLD 1 may be the same as the power-saving configuration information transmitted by the STA MLD 1.

Upon receiving a reception response frame for the frame including the MAC header with the power-saving configuration information, the STA MLD 1 may perform a power-saving operation in a subsequent transmission procedure. If the power-saving operation is performed based on the MAC header including the power-saving configuration information, the power-saving operation may be applied to a TXOP configured by the frame with the MAC header including the power-saving configuration information. Alternatively, if the power-saving operation is configured by the frame including the power-saving configuration information, the power-saving operation may continue until a frame including deactivation information of the power-saving operation is received.

The STA MLD 1 (e.g., STA 1-1 and/or STA 1-2) may transmit deactivation information for the power-saving operation to the AP MLD 1 (e.g., AP 1-1 and/or AP 1-2). The deactivation information for the power-saving operation may be included in an action frame and/or data frame. The AP MLD 1 may receive the deactivation information for the power-saving operation from the STA MLD 1. In this case, the AP MLD 1 may determine that the power-saving operation of the STA MLD 1 is deactivated. The AP MLD 1 may transmit a response frame (e.g., ACK frame) for the deactivation information of the power-saving operation to the STA MLD 1. Upon receiving the response frame for the deactivation information of the power-saving operation, the STA MLD 1 may determine that the power-saving operation is deactivated and may not perform the power-saving operation.

In the exemplary embodiment of FIG. 6C, the power-saving operation may be configured in an association procedure and/or multi-link setup procedure. The power-saving configuration information may be included in an association request frame, an association response frame, and/or a frame according to the multi-link setup procedure. For example, separate information elements for the power-saving configuration information may be included in the association request frame and/or association response frame. Once the association procedure and/or multi-link setup procedure is completed, the power-saving operation may be performed. To deactivated the power-saving operation after the association procedure and/or multi-link setup procedure is completed, the operation of indicating the deactivation of the power-saving operation described in the exemplary embodiments of FIG. 6A and/or FIG. 6B may be performed.

In the exemplary embodiments of FIGS. 3A to 3C, the exemplary embodiments of FIGS. 4A and 4B, and the exemplary embodiments of FIGS. 5A and 5B, the power-saving operation may be configured based on the methods according to the exemplary embodiments of FIGS. 6A to 6C.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first device, comprising:
allowing a first station (STA) affiliated with the first device to perform communication with a first access point (AP) on a first link;
allowing a second STA affiliated with the first device to perform a power-saving operation on a second link, during a period in which the communication is performed on the first link; and
allowing the second STA to operate in an awake state on the second link instead of the power-saving operation, after the communication is completed on the first link,
wherein the first device is a device having a non-simultaneous transmit and receive (NSTR) link pair, and the NSTR link pair is a pair of the first link and the second link.

2. The method according to claim 1, wherein the period in which the communication is performed corresponds to a length of a frame transmitted by the first STA.

3. The method according to claim 1, wherein the period in which the communication is performed corresponds to a transmit opportunity (TXOP) configured for the communication.

4. The method according to claim 1, wherein the period in which the communication is performed corresponds to ‘a transmission/reception period of a frame for configuring a TXOP for the communication+the TXOP’.

5. The method according to claim 1, wherein the power-saving operation on the second link is performed during ‘the period in which the communication is performed on the first link+enhanced multi-link single radio (EMLSR) transition delay’.

6. The method according to claim 5, wherein the EMLSR transition delay is a time required for a frame transmission/reception procedure in a listening operation according to EMLSR or a time required for transition to the listening operation after completion of the frame transmission/reception procedure.

7. The method according to claim 1, further comprising, before performing the communication on the first link,
transmitting, to the first AP, a frame including power-saving configuration information to the first AP on the first link in order for the first STA to configure the power-saving operation; and
receiving a reception response frame for the frame from the first AP.

8. The method according to claim 7, wherein the frame is an action frame, a data frame, an association request frame, or a frame according to a multi-link setup procedure.

9. The method according to claim 7, wherein the power-saving configuration information includes at least one of an indicator indicating whether to perform the power-saving operation, a bitmap indicating link(s) on which the power-saving operation is performed, or a mode of the power-saving operation, and a period in which the power-saving operation is performed varies depending on the mode.

10. The method according to claim 1, further comprising:
allowing the first STA to transmit a frame including deactivation information of the power-saving operation to the first AP on the first link; and
receiving, from the first AP, a reception response frame for the frame,
wherein the power-saving operation is deactivated by the deactivation information, and when the power-saving operation is deactivated, the first device does not perform the power-saving operation.

11. A first device comprising at least one processor, wherein the at least one processor causes the first device to perform:
allowing a first station (STA) affiliated with the first device to perform communication with a first access point (AP) on a first link;
allowing a second STA affiliated with the first device to perform a power-saving operation on a second link, during a period in which the communication is performed on the first link; and
allowing the second STA to operate in an awake state on the second link instead of the power-saving operation, after the communication is completed on the first link,
wherein the first device is a device having a non-simultaneous transmit and receive (NSTR) link pair, and the NSTR link pair is a pair of the first link and the second link.

12. The first device according to claim 11, wherein the period in which the communication is performed corresponds to a length of a frame transmitted by the first STA.

13. The first device according to claim 11, wherein the period in which the communication is performed corresponds to a transmit opportunity (TXOP) configured for the communication.

14. The first device according to claim 11, wherein the period in which the communication is performed corresponds to ‘a transmission/reception period of a frame for configuring a TXOP for the communication+the TXOP’.

15. The first device according to claim 11, wherein the power-saving operation on the second link is performed during ‘the period in which the communication is performed on the first link+enhanced multi-link single radio (EMLSR) transition delay’.

16. The first device according to claim 11, wherein the at least one processor further causes the first device to perform, before performing the communication on the first link,
transmitting, to the first AP, a frame including power-saving configuration information to the first AP on the first link in order for the first STA to configure the power-saving operation; and
receiving a reception response frame for the frame from the first AP.

17. The first device according to claim 16, wherein the frame is an action frame, a data frame, an association request frame, or a frame according to a multi-link setup procedure.

18. The first device according to claim 16, wherein the power-saving configuration information includes at least one of an indicator indicating whether to perform the power-saving operation, a bitmap indicating link(s) on which the power-saving operation is performed, or a mode of the power-saving operation, and a period in which the power-saving operation is performed varies depending on the mode.

19. The first device according to claim 11, wherein the at least one processor further causes the first device to perform:
allowing the first STA to transmit a frame including deactivation information of the power-saving operation to the first AP on the first link; and
receiving, from the first AP, a reception response frame for the frame,
wherein the power-saving operation is deactivated by the deactivation information, and when the power-saving operation is deactivated, the first device does not perform the power-saving operation.
